(19) United States
(12) Patent Application Publication
(10) Pub. No.: US 2007/0076022 A1
(43) Pub. Date: Apr. 5, 2007

(54) Driving circuit of a piezoelectric element, and liquid droplet ejecting device

(75) Inventor: Fuminori Takizawa, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/447,353

(22) Filed: Jun. 6, 2006

(30) Foreign Application Priority Data
Oct. 5, 2005 (JP) 2005-292539

(51) Int. Cl. B41J 29/38

(52) U.S. Cl. 347/5

(57) ABSTRACT

A driving circuit of liquid droplet ejecting head is disclosed for ejecting liquid droplets from a liquid droplet ejector by causing a pressure chamber of the liquid droplet ejector to be expanded and contracted in response to changes in a voltage applied to a piezoelectric element provided as an actuator. The driving circuit includes a power source that outputs power of a specified voltage which is applied to the piezoelectric element, a first switching element provided between the power source and the parallel connected piezoelectric element and discharging element, the first switching element being opened and closed in accordance with a first operation signal inputted thereto.

### CROSS-REFERENCE TO RELATED APPLICATION

This application claims priority under 35 USC 119 from Japanese Patent Application No. 2005-292539, the disclosure of which is incorporated by reference herein.

### TECHNICAL FIELD

The invention relates to a liquid droplet ejecting device for ejecting liquid droplets, such as ink droplets, from a liquid droplet ejector, and more particularly to a driving circuit of a piezoelectric element provided as an actuator in a liquid droplet ejector, and a liquid droplet ejecting device.

### RELATED ART

Liquid droplet ejecting devices include ink jet recording devices having an ink jet recording head as a liquid droplet ejecting head, and these ink jet recording devices are classified into thermal type, and piezoelectric type, having a piezo element or piezoelectric element as an actuator.

In liquid droplet ejectors having a piezoelectric element as an actuator, the volume (capacity) is changed by expansion and contraction of a pressure chamber filled with ink by a piezoelectric element, and by such changes of internal pressure, droplets of ink are ejected from the leading end of a nozzle communicating with the pressure chamber, known as a “drop on-demand” system.

In such ink jet recording devices, a high image quality is demanded together with high printing speed, and hence there is a high density of the nozzles for ink droplets ejection. Also in the ink jet recording device, print gradation can be enhanced by controlling the droplet ejection amount. In such a case, it is preferable to correct the droplet ejecting amount in accordance with the characteristics of each nozzle.

In liquid droplet ejectors using a piezoelectric element as an actuator, when analog waveform driving the piezoelectric element to form the desired waveform shape, by adjusting the peak value of waveform, ink droplets can be ejected at a desired droplet diameter and liquid speed, and hence the print gradation can be enhanced, and the droplet ejecting amount can be corrected in accordance with the characteristics of each liquid droplet ejector.

Here, by providing a driving waveform generating unit for generating mutually different plural analog driving waveforms, it has been proposed to apply the desired selected driving waveform to each piezoelectric element.

However, to generate an analog driving waveform of piezoelectric element suited to the characteristic of each liquid droplet ejector, plural expensive waveform generating circuits of large power consumption are needed, which leads to increased manufacturing costs of ink jet recording devices and increased power consumption.

On the other hand, piezoelectric elements charge and discharge depending on the driving waveform, and a technique has been proposed in which, when rectangular waveform driving is performed by using a pulse driving waveform of a set voltage, the pulse width or on/off timing of a waveform shape is adjusted by a logic signal.

Thus, multiple driving waveforms, which have the same amplitude but are different in on/off timing, can be easily obtained without requiring an expensive waveform generating circuit

However, in the proposal described above in the above paragraph [0008], since the characteristics are substantially the same in charging and discharging, by just controlling the discharge time and charge time, it is hard to control the gradation or to correct the liquid droplet ejecting amount in each liquid droplet ejector. That is, although it is easy to control the pressure generating timing by piezoelectric element, it is hard to control the peak value of driving waveform, and there is the problem that the adjustment range of liquid droplet ejecting amount is narrow.

A technique has also been proposed in which a waveform generating circuit is provided, charging and discharging the capacitor is carried out smoothly by on/off-controlling a transistor using a logic control signal, that is, by using a trapezoidal waveform, the peak value, in addition to the rise time and fall time, of a driving waveform to be applied to the piezoelectric element.

Further, a technique has been proposed in which similarly a waveform generating circuit is provided to generate a voltage waveform having a region with a gradual slope of voltage change, a switching element is disposed between the waveform generating circuit and the piezoelectric element, and a driving waveform of the desired peak value is applied to the piezoelectric element by controlling on/off timing of switching element.

By utilizing the technique described above in paragraph [0012], it is possible to enhance print gradation by modulation of liquid droplet diameter and by on/off control of the switching element, or correct for fluctuations particular to each liquid droplet ejector.

However, the techniques described above in the above paragraphs [0011] and [0012] require a waveform generating circuit for generating an analog waveform, rather than a rectangular wave, and so both of them require a waveform generating circuit of a complicated structure for driving the piezoelectric element.

### SUMMARY

The invention has been made in view of the above circumstances and provides a driving circuit of a piezoelectric element.

A first aspect of the invention provides a driving circuit of a piezoelectric element provided as an actuator in a liquid droplet ejector in order to enable the liquid droplet ejector to eject a liquid droplet(s) by causing a pressure chamber of the liquid droplet ejector to be expanded and contracted in accordance with changes in a voltage applied to the piezoelectric element, comprising: a power source that outputs power of a specified voltage which is applied to the piezoelectric element; a discharging element connected in parallel with the piezoelectric element; and a first switching element provided between the power source and the parallel connected piezoelectric element and discharging element, the first switching element being opened and closed in accordance with a first operation signal inputted thereto.

Other aspects, features and advantages of the invention will become apparent from the following description taken in conjunction with the accompanying drawings.

### BRIEF DESCRIPTION OF THE DRAWINGS

Embodiments of the invention will be described in detail based on the following figures, in which:

FIG. 1 is a schematic structural view of the ink jet recording device according to an embodiment of the invention;

FIG. 2 is a block diagram illustrating an ejection control of ink droplets;

FIG. 3 is a schematic structural view showing an example of a liquid droplet ejector;

FIG. 4 is a block diagram of the driving circuit according to a first embodiment of the present invention;

FIG. 5 is a graph illustrating changes of terminal voltage with time as an example of the discharge characteristic of the piezoelectric element in the driving circuit shown in FIG. 4.

FIG. 6 is a view illustrating changes of terminal voltage of piezoelectric element with respect to discharge control signal in the first embodiment.

FIG. 7 is a view illustrating another example of changes of terminal voltage of piezoelectric element with respect to discharge control signal in the first embodiment.

FIG. 8 is a block diagram of driving circuit according to a second embodiment.

FIG. 9 is a view illustrating changes of discharge control signal and terminal voltage of piezoelectric element with respect to discharge control signal in the second embodiment.

### DETAILED DESCRIPTION

Embodiments of the invention will be described below with reference to the accompanying drawings.

### First Embodiment

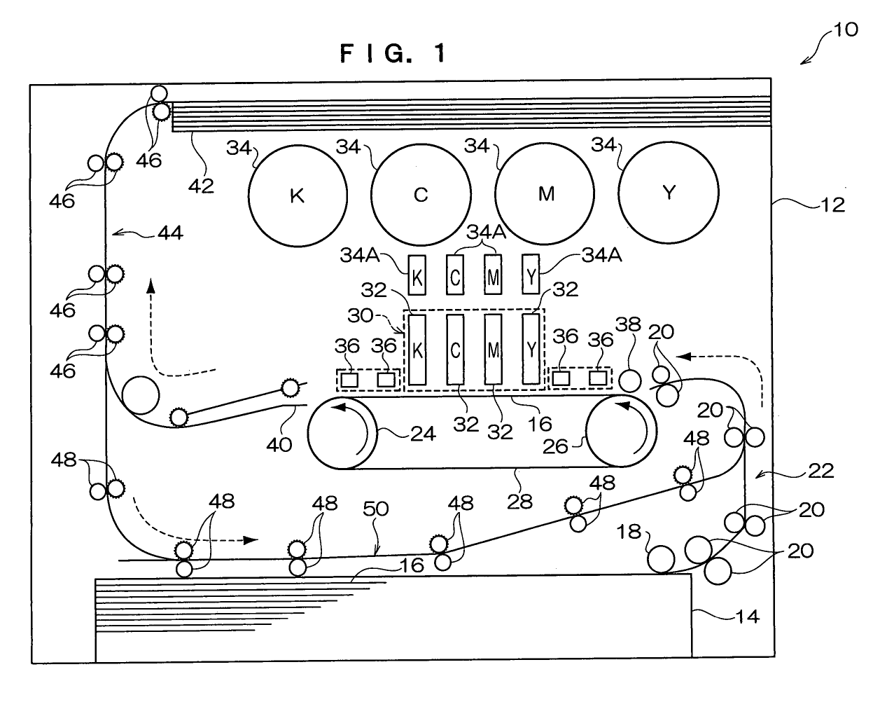

FIG. 1 shows a schematic structural view of an ink jet recording device 10 applied as a liquid droplet ejecting device in a first embodiment of the invention.

The ink jet recording device 10 includes a paper feed tray 14 provided in the lower part of a enclosure 12. Layers of paper sheets 16 as recording medium are stacked in the paper feed tray 14, and the paper sheets 16 contained in the paper feed tray 14 are picked up one by one from the highest layer by a pickup roll 18.

The paper 16 taken out of the paper feed tray 14 is conveyed along a conveying path 22 for feeding paper formed in the enclosure 12 by a pair of conveying rollers 20.

In the enclosure 12, there is an endless conveying belt 28 stretched between a driving roll 24 and a driven roll 26 disposed above the paper feed tray 14. The conveying belt 28 is driven and rotated by the driving roll 24.

Above the conveying belt 28, a recording head array 30 is disposed as a liquid droplet ejecting head. The recording head array 30 is in opposition to a flat portion of the conveying belt 28 between the driving roll 24 and driven roll 26, and the opposite region of the recording head array 30 is the ejecting region where ink droplets are ejected from the recording head array 30.

The paper 16 conveyed through the conveying path 22 is held by the conveying belt 28, and is further conveyed toward the ejecting region. The recording head array 30 ejects ink droplets according to image information, at the timing of the paper 16 passing this ejecting region, and the ejected ink droplets are adhered to the paper 16, and an image is recorded on the paper 16 according to the image information.

In the ink jet recording device 10, by rotationally moving the conveying belt 28 which is holding the paper 16, the sheet is passed plural times through the ejecting region, whereby it is possible to carry out “multipass” image recording.

Rather than using the conveying belt 28 it is also possible, for example, that the paper 16 may be attracted and attached to the outer circumference of a cylindrical or columnar conveying roll, and rotated, and the paper 16 may be held in opposition to the ejecting region. Here, by curving the ejecting region around the circumference of the conveying roller, the interval of the recording head array and the paper 16 may be kept almost uniform in the ejecting region.

The recording head array 30 of the ink jet recording device applied in the embodiment is long enough so that the effective image recording area (ink droplet ejecting region) may be wider than the length in a direction orthogonal to the conveying direction of paper 16, and consists of four ink jet recording head units corresponding to four colors of yellow (Y), magenta (M), cyan (C), and black (K) (hereinafter, referred to simply as head units 32) disposed along the conveying direction. Thus, full-color image recording is possible in the ink jet recording device 10.

The recording head array 30 is structured so as to be nonmovable in a direction orthogonal to the conveying direction, but a structure may be used in which it is movable in such a direction if necessary, and hence image recording of higher resolution is possible with multipass image recording, defects in liquid droplet ejection can be prevented from the appearing in the recording results. The recording head array 30 is not limited to this example, but it may be designed to move in the main scanning direction, where the width direction of the paper 16 is defined as the main scanning direction.

The enclosure 12 incorporates ink tanks 34 for reserving inks of Y, M, C and K, and each head unit 32 has a reservoir tank 34A corresponding to the ink tank 34. As the ink in the reservoir tank 34A is ejected toward the paper 16 from each of the head unit 32, the ink in the ink tank 34 is replenished in the reservoir tank 34A by way of ink refill pipe not shown.

Near the recording head array 30, four maintenance units 36 are disposed corresponding to four head units 32. At the time of maintenance of head units 32 by using the maintenance units 36, the maintenance units 36 are moved into a gap formed between the conveying belt 28 and recording head array 30, and the maintenance units 36 are held in opposition to the nozzle surface (the side of conveying belt 28) of the head units 32, respectively.

In this state, the maintenance units 36 perform specified maintenance actions including vacuuming, dummy jet, wiping, and capping. The maintenance units 36 are divided into two sets of two units each, and disposed at the upstream side and downstream side in the conveying direction of paper 16 on both sides of the recording head array 30.

In the ink jet recording device 10, a charging roll 38 is provided in opposition to the conveying belt 28, at the side of the conveying path 22 of the recording head array 30. The charging roll 38, together with the driven roll 26, grips and moves the conveying belt 28 and the paper 16, and moves the paper 16 between a pressed position where pressed against the conveying belt 28, and a released position where separated from the conveying belt 28.

The charging roll 38 receives electric power of a specified voltage from a power source not shown, and a potential difference is produced between the charging roll 38 and the grounded driven roll 26 so that electric charges are applied to the paper 16 due to this potential difference. As a result, the paper 16 is electrostatically attracted and attached to the conveying belt 28. The ink jet recording device 10 has an unillustrated register roll at the upstream side of the conveying direction of paper 16 from the charging roll 38, and by this register roll, the paper 16 is placed, while being conveyed, into the gap between the conveying belt 28 and charging roll 38.

At the downstream side of the conveying direction of paper 16 from the recording head array 30, a separator plate 40 is provided, and the recorded paper 16 is released from the conveying belt 28 by this separator plate 40. At the lower side of the separator plate 40, a cleaning roll (not shown) is disposed for nipping the conveying belt 28 together with the driving roll 24, and the surface of the conveying belt 28 from which the paper 16 is released is cleaned by the cleaning roll.

On the top of the enclosure 12, a catch tray 42 is provided, and at the downstream side of sheet conveying direction of the separator plate 40, a sheet discharge path 44 is formed for conveying the paper 16 toward the catch tray 42.

The sheet discharge path 44 includes a pair of conveying rollers 45, and the paper 16 released from the conveying belt 28 by the separator plate 40 is conveyed by the conveying rollers 46, and is discharged and collected on the catch tray 42.

Between the paper feed tray 14 and conveying belt 28, an inverting path 50 is formed by the pair of conveying rollers 48.

The paper 16 having an image recorded on one side and being fed into the discharge path 44 is further conveyed into this inverting path 50, and is inverted and fed into the conveying path 2 for feeding paper. As a result, in the ink jet recording device 10, the image can be recorded on both sides of the paper 16.

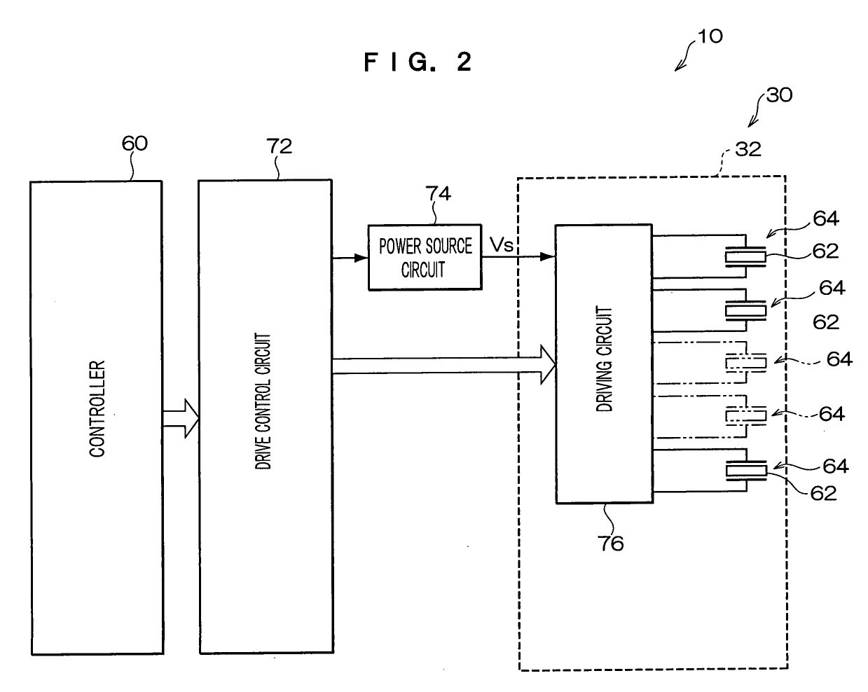

On the other hand, as shown in FIG. 2, the ink jet recording device 10 includes a controller 60 for controlling ejection of ink droplets using the recording head array 30. In ink jet recording device 10, image data is inputted from an image processing device such as personal computer or work station, and the controller 60 controls ejection of ink droplets by the head units 32 of the recording head array 30 according to the image data, so that an image according to the image data is recorded on the paper 16.

As mentioned above, the recording head array 30 is longer than the width of the paper 16, and the head units 32 for the respective colors have nozzles disposed closely to each other for ejecting ink droplets along the width direction of the paper 16.

The head units 32 are disposed two-dimensionally, arranging the nozzles in plural rows, such as for example four rows, so that the nozzles of each row do not overlap along the conveying direction of paper 16, and the nozzles are dispose closely to each other in the width direction of the paper 16. The liquid droplet ejecting head of the invention is not limited to this example, and other structures may be used.

In the ink jet recording device 10 that is structured as described above, in response to image data being inputted, the paper 16 stacked on the paper feed tray 14 is conveyed through the conveying path toward the gap between the driven roll 26 and charging roll 38. When the paper 16 is fed into the gap between the driven roll 26 and charging roll 38, it is held by the driven roll 26 and charging roll 38 together with the conveying belt 28, and is pressed against the conveying belt 28 and held on the conveying belt 28.

The paper 16 held on the conveying belt 28 passes through the ejecting region in opposition to the head units 32 of the recording head array 30 by circulating movement of the conveying belt 28, and the ink droplets are ejected from the head units 32 based on image data, so that an image is recorded on the paper 16 based on the image data.

Here, when the image is recorded by a single pass, the paper 16 is released from the conveying belt 28 by the separator plate 40, and the released paper 16 is conveyed along the discharge path 44 and is discharged into the catch tray 42. In the case of multipass image recording, by circulatory movement of the conveying belt 28, the paper 16 passes the ejecting region plural times, and the image is recorded, and after the image recording, the paper 16 is released from the conveying belt 28, and discharged into the catch tray 42.

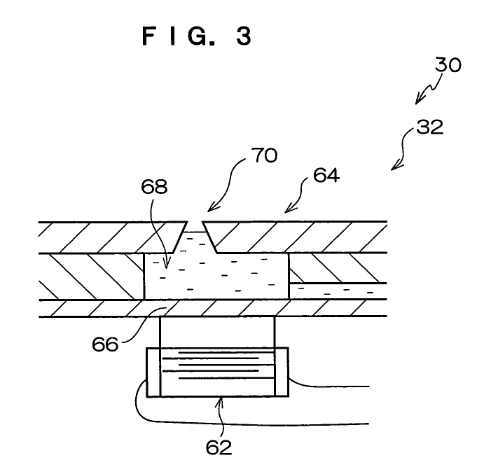

The head unit 32 also has a liquid droplet ejector 64 for ejecting ink droplets. As shown in FIG. 3, the ink droplet ejector 64 uses a piezoelectric element 62 as a pressure generating element that serves as an actuator. The liquid droplet ejector 64 is composed of a diaphragm 66, pressure chamber (pressure generating chamber) 68, and nozzle section 70.

The piezoelectric element 62 is deformed in response to a voltage applied thereto, and vibrates the diaphragm 66 forming a part of the wall of pressure chamber 68 of liquid droplet ejector 64. At this time, when the applied voltage is decreased, the piezoelectric element 62 causes the diaphragm 66 to be vibrated in a manner such that the pressure chamber 68 is expanded, while when the applied pressure is increased, the piezoelectric element 62 causes the diaphragm 66 to be vibrated in a manner such that the pressure chamber 68 is contracted.

As a result of the pressure chamber 68 being expanded or contracted due to the vibration of diaphragm 66, the liquid droplet ejector 64 is enabled to eject the ink in the pressure chamber 66 as ink droplets from the nozzle section 70.

The ink droplet ejector 64 may be realized by using a well known general structure for the piezoelectric element 62. The basic structure of Y, M, C and K color head units 32 provided in the recording head array 30 are the same, and only the head unit 32 of one color is explained below.

As shown in FIG. 2, a drive control circuit 72 is connected to the controller 60, and a power source circuit 74 and head unit 32 are connected to the drive control circuit 72.

The power source circuit 74 is a constant voltage source, and provides the head unit 32 with power of a predetermined voltage Vs as driving power for the piezoelectric element 62.

In the head unit 32 is also provided a driving circuit 76 to which the piezoelectric elements 62 are connected. A drive control circuit 72 may be provided in each one of Y, M, C and K color head units 32, and each may be connected to the controller 60, or the Y, M, C and K color head units 32 may be connected to a single drive control circuit 72.

The controller 60 outputs clock signal, print data corresponding to image data, latch signal, and so forth to the drive control circuit 72, and the drive control circuit outputs to the driving circuit 76 a control signal for controlling driving of each piezoelectric element 62 of head unit 32.

The driving circuit 76 provides power supplied from the power source circuit 74 to the piezoelectric elements 62 based on a control signal inputted from the drive control circuit 72. The piezoelectric elements 62 are driven in response to power supplied from the driving circuit 76 thereto.

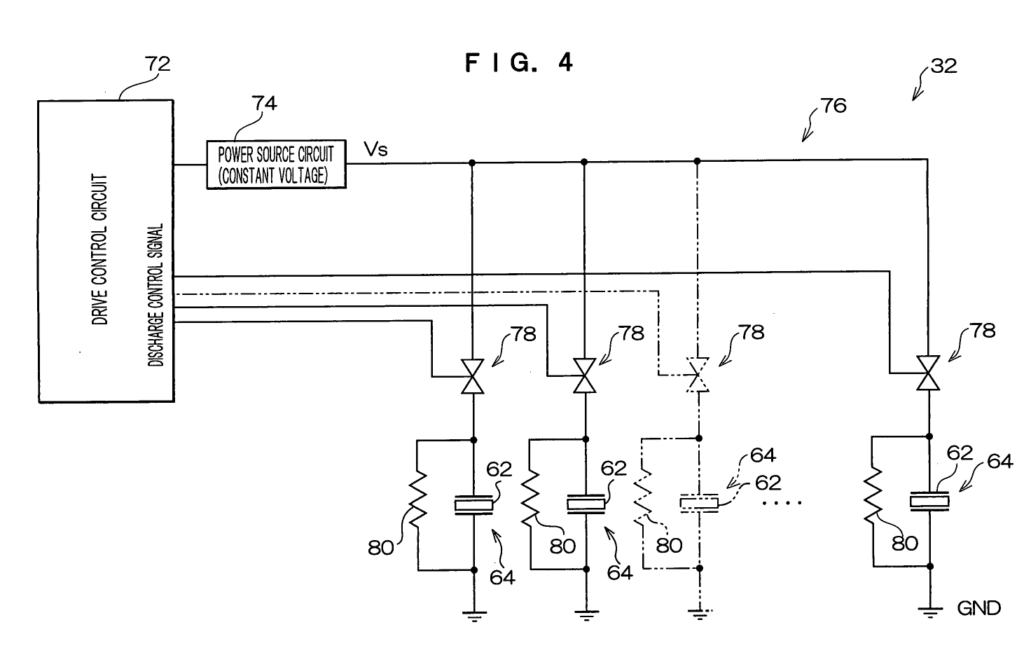

FIG. 4 shows the driving circuit 76 according to the first embodiment. The driving circuit 76 has a gate switch 78, used as the first switching element, corresponding to each of the piezoelectric elements 62. The gate switch 78 is connected in series to the piezoelectric element 62, and voltage Vs is applied from the power source circuit 74 to the piezoelectric element 62 through the gate switch 78.

The gate switch 78 receives a control signal from the drive control circuit 72 and is turned on/off in response to the control signal, and when the gate switch 78 is in an on state, a voltage Vs of power source circuit 74 is applied to the piezoelectric element 62.

Meanwhile, the driving circuit 76 includes resistors 80 provided as discharging elements. The resistors 80 are connected in parallel to the piezoelectric elements 62, respectively.

The piezoelectric element 62 using a piezo element has an electrostatic capacity, and when the gate switch 78 is turned on the electric power supplied from the power source circuit 74 is accumulated so that the terminal voltage V becomes the voltage Vs supplied from the power source circuit 74.

In the driving circuit 76, when the gate switch 78 is turned off, the electric charge accumulated in the piezoelectric element 62 is discharged through the resistor 80 connected in parallel to the piezoelectric element 62, and thus the terminal voltage of the piezoelectric element 62 is decreases as time lapses.

At this time, the time constant τ is determined by the electrostatic capacity Cp of piezoelectric element 62 and resistance value R of resistor 80 (τ=Cp×R).

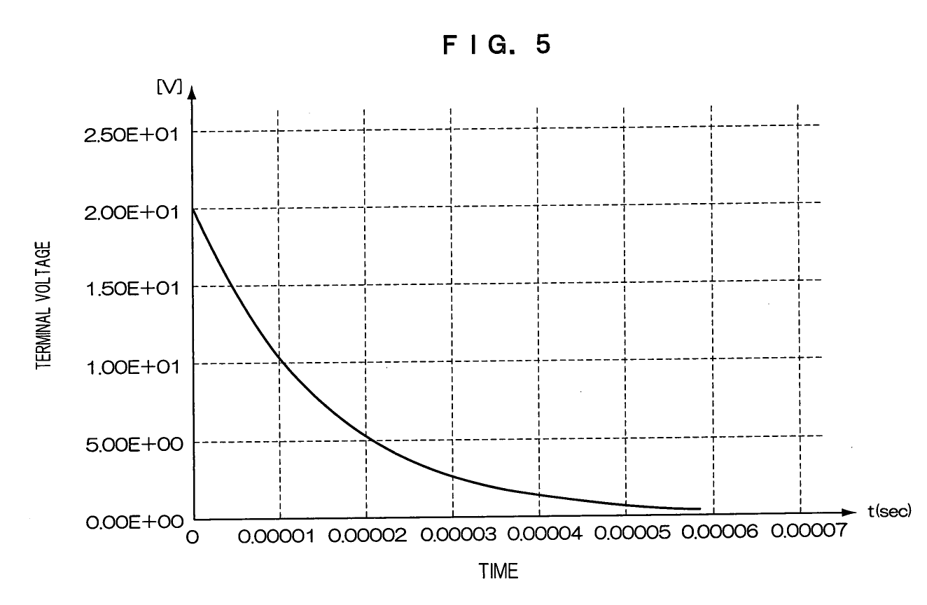

FIG. 5 shows an outline of discharge characteristics of piezoelectric element 62 in the driving circuit 76. As an example of discharge characteristics, a case is shown in which the piezoelectric element 62 is charged at voltage Vs=20 V, where the electrostatic capacity Cp of piezoelectric element 62 is 600 pF (picofarad) and the resistance value R of resistance 80 is 25 kΩ.

In the driving circuit 76 shown in FIG. 4, discharge is interrupted as a result of the gate switch 78 being turned on during discharge of piezoelectric element 62, and simultaneously the piezoelectric element 62 is charged by the electric power supplied from the power source circuit 74 so that the terminal voltage V of piezoelectric element 62 is abruptly increased up to the voltage Vs.

The voltage change (potential difference ΔV) at this time varies with the discharge time. That is, depending on the time Δt during which the gate switch 78 remains turned off, the terminal voltage V of piezoelectric element 62 varies, and the potential difference ΔV from the terminal voltage at the time of charging changes. This potential difference is the amplitude (peak value) of voltage applied to the piezoelectric element 62 when the gate switch 78 is turned on and off.

Consequently, the piezoelectric element 62 operates such that the amplitude of a voltage applied thereto varies depending on the time (off-time) Δt during which gate switch 78 remains turned off.

On the other hand, when the terminal voltage V is increased, the piezoelectric element 62 causes the diaphragm 66 of liquid droplet ejector 64 to be vibrated in a manner such that the pressure chamber 68 is contracted, while when the terminal voltage V is decreased, the piezoelectric element 62 causes the pressure chamber 68 to be expanded. Due to a sudden contraction/expansion of the pressure chamber 68, the liquid droplet ejector 64 ejects ink droplets from the nozzle section 70. The amount of ejected ink droplet (ejected droplet amount) varies with the potential difference ΔV of terminal voltage, that is, the amplitude (peak value) when the terminal voltage V is changed.

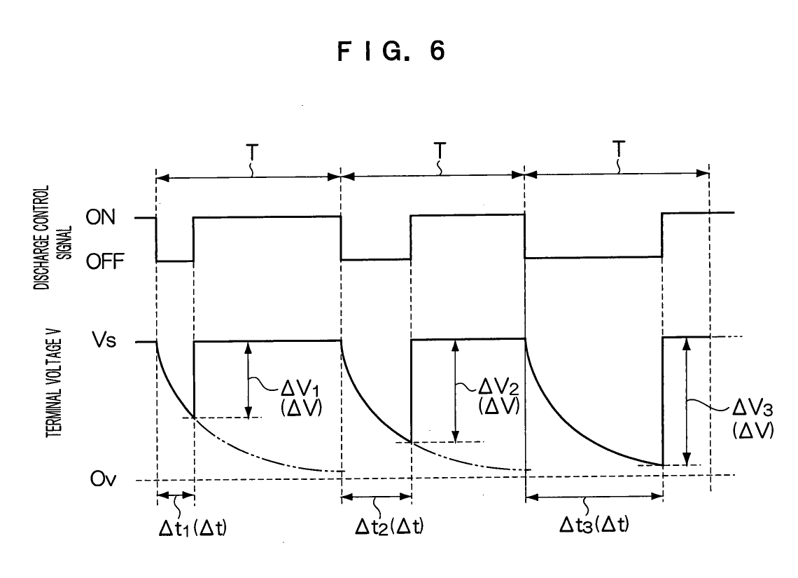

That is, as shown in FIG. 6, when the off-time lengths of switching gate 78, Δt1, Δt2, Δt3 are in a relationship such that Δt1<Δt2<Δt3, potential differences ΔV1, ΔV2, ΔV3 are in a relationship such that ΔV1<ΔV2<ΔV3.

Thus, for the off-time Δt1, the ejected droplet amount is small, and is larger in the in progression for off-times Δt2 and Δt3.

In the drive control circuit 72, the off-time Δt of each piezoelectric element 62 is set based on a control signal from the controller 60, and, the gate switch 78 is turned on and off based on the set off-time Δt, thus driving the piezoelectric element 62 so that ink droplets are ejected from the liquid droplet ejector 74. In the following explanation, the control signal of gate switch 78 is called a discharge control signal.

For example, if the ejected droplet amount of ink droplets is classified into three levels such as small drop, medium drop and large drop, then the corresponding off-time periods Δt of gate switch 78 (for example, Δt1, Δt2, Δt3) are predetermined, and stored in the drive control circuit 72.

Therefore, in the drive control circuit 72, a control signal based on the dot diameter to be formed on the paper 16 by ink droplets ejected from the liquid droplet ejector 62 is inputted from the controller 60, and the off-time Δt of gate switch 78 is set based on the inputted control signal, and a control signal (discharge control signal) is outputted so as to turn off the gate switch 78 during the set off-time Δt.

In the ink jet recording device 10 configured as described above, the ejection period of each ink droplet ejector 64 for obtaining the desired resolution and print speed is determined depending on the density of, and the sub-scanning speed of, the nozzles (nozzle section 78) in the head unit 32. From this ejection period, the print period T for ejecting ink droplets for one dot is determined. In the driving circuit 76, for example, from this print period T, the decay time constant τ during discharge of piezoelectric element 62 can be determined.

When the discharge period is 18 kHz, if decay time constant τ of 15 usec is needed, the resistance value R of the resistor 80 is determined so as to obtain such a decay time constant τ. The resistance value R is calculated based on the electrostatic capacity Cp (from measuring the electrostatic capacity Cp of piezoelectric element 62 of liquid droplet ejector 64) and decay time constant τ, and when the electrostatic capacity Cp of piezoelectric element 62 is, for example, 600 pF, the resistance value R is determined to be 25 kΩ from this electrostatic capacity Cp and time constant τ.

Thus, when the output voltage Vs from the power source circuit 74 is 20 V, the terminal voltage V of piezoelectric element 62 is variable between 20 V and 1 V within print period T. That is, the peak value when driving the piezoelectric element 62 can be controlled within the range of 20 V to 1 V.

In the ink jet recording device 10, the off-time Δt of gate switch 78 for dot diameter modulation is set for each dot diameter, that is, for each droplet ejection amount.

For example, classifying the dot diameter into the three levels of small droplet, medium droplet and large droplet, the off-time length Δt (Δt1, Δt2, Δt3) is set based on the ejected droplet amount for obtaining each dot diameter, and a table of the preset off-time lengths Δt is stored in the drive control circuit 72. The drive control circuit 72 sets the off-time Δt of gate switch 78 from the ejected droplet amount of each liquid droplet ejector 64, and outputs the discharge control signal at a preset off-time Δt, thereby driving the gate switch 78.

Meanwhile, although the table of off-time Δt is stored in the drive control circuit 72 in this example, it may also be arranged that such a table is stored in the controller 60, and the controller 60 outputs to the drive control circuit 72 a control signal which is based on the off-time Δt determined depending on the ejected droplet amount. Alternatively, the driving circuit 76 may be provided with a memory, and the table of off-time Δt may be stored in this memory.

On the other hand, the drive control circuit 72 starts a printing process when each gate switch 78 of the driving circuit 76 is turned on so that the piezoelectric element 62 is charged with the voltage Vs. When the piezoelectric element 62 is charged prior to the printing process, it is preferably arranged that while each gate switch 78 is turned on, the output voltage Vs of the power source circuit 74 is gradually increased so as to prevent the terminal voltage V of the piezoelectric element 62 from being abruptly changed.

When the print timing for ejecting ink droplets from the ink droplet ejector 64 based on the control signal inputted from the controller 60 is reached, the drive control circuit 72 causes the gate switch 78 of the driving circuit 76 to be turned off by the discharge control signal outputted to the driving circuit 76, and after a lapse of predetermined off-time Δt, the gate switch 78 is turned on.

Due to the gate switch 78 of the driving circuit 76 being turned on, the piezoelectric element 62 is charged by the power supplied from the power source circuit 74 so that the terminal voltage V is held at the voltage Vs of power source circuit 74. However, when the gate switch 78 is turned off, the piezoelectric element 62 is discharged via the resistor 80 connected in parallel therewith so that the terminal voltage V is decreased depending on the time constant τ and elapsing time. When the gate switch 78 is turned on during discharge, charging to piezoelectric element 62 is started, and thus the terminal voltage V of piezoelectric element 62 is restored to the voltage Vs.

Consequently, a voltage change of peak value corresponding to the off-time Δt of gate switch 78 occurs between the pair of terminals of piezoelectric element 62, and due to this voltage change, the pressure chamber 66 of the liquid droplet ejector 64 is contracted so that ink droplets are ejected from the nozzle section 70.

As shown in FIG. 6, the terminal voltage V of piezoelectric element 62 varies with off-time Δt of gate switch 78. Here, as the width of terminal voltage V, potential difference ΔV, is changed the potential difference is ΔV1 at off-time Δt1, potential difference is ΔV2 (ΔV2>ΔV1) at off-time Δt2 (Δt2>Δt1), and potential difference is ΔV3 (ΔV3>ΔV2) at off-time Δt3 (Δt3>Δt2).

Such off-times Δt can be set into three or more levels arbitrarily, and hence in the ink jet recording device 10, the print gradation can be enhanced, and an image of high quality can be formed on the paper 16.

Time constant τ during discharge can be adjusted based on the resistance value R of resistor 80 which is provided as a discharge element for the piezoelectric element 62, and by shortening the time constant τ, the print period T can be shortened, so that the print speed can be enhanced.

Such driving of piezoelectric element 62 may be also realized by a driving circuit 76 having a simple structure that uses gate switches 78 and resistors 80.

On the other hand, in the liquid droplet ejector 64, eve if the peak values (potential differences ΔV) of voltages applied to the piezoelectric elements 62 are the same, the ejected droplet amount has an individual difference. If the electrostatic capacity Cp of the individual piezoelectric elements 62 are different, it is likely that individual differences of the injected droplet amount of the ink droplet ejector 64 and the individual difference of the electrostatic capacity Cp of the piezoelectric element 62 may lead to uneven printing on paper 16 or a decrease of image printing quality.

In the driving circuit 76, since the gate switch 78 is turned on and off for each piezoelectric element 62, and hence the off-time Δt corresponding to the ejected droplet amount can be set for each piezoelectric element 62.

Thus, the individual difference of ejected droplet amount of liquid droplet ejector 64 is taken into consideration when the off-time Δt of piezoelectric element 62 is set for each liquid droplet ejector 64. At this time, for example, correction is made such that the off-time Δt is longer for the piezoelectric element 62 of liquid droplet ejector 64 having a smaller ejected droplet amount.

As a result, image recording of high quality is realized by suppressing unevenness of ejected droplet amount due to individual difference of liquid droplet ejector 64, or of piezoelectric element 62 provided in the liquid droplet ejector 64.

Meanwhile, the electrostatic capacity Cp of piezoelectric element 62, ink viscosity (fluidity), or ejection state of liquid droplets from nozzle section 70 may vary depending on ambient temperature or ambient humidity, and these changes may cause changes in the density of image printed on the paper 16.

At this time, for example, by detecting the temperature (ambient temperature) or humidity (ambient humidity) in the enclosure 12, the off-time Δt of discharge control signal can be corrected based on the result of detection, so that changes of print quality can be securely prevented depending on the ambient temperature and ambient humidity.

Herein, the gate switch 78 is turned off first in one print period T, but the on/off timing of gate switch 78 may be set arbitrarily in one print period.

The ink droplet ejector 64 ejects ink droplets at the timing with which the terminal voltage V of piezoelectric element 62 builds up to the voltage Vs. Accordingly, when the gate switch 78 is turned off at first timing in one print period, the ejecting timing of ink droplets varies depending on the ejected droplet amount.

By setting constant the timing for turning on the gate switch 78 which is in OFF state in one print period, the ink droplet landing positions, that is, the dot forming positions can be aligned.

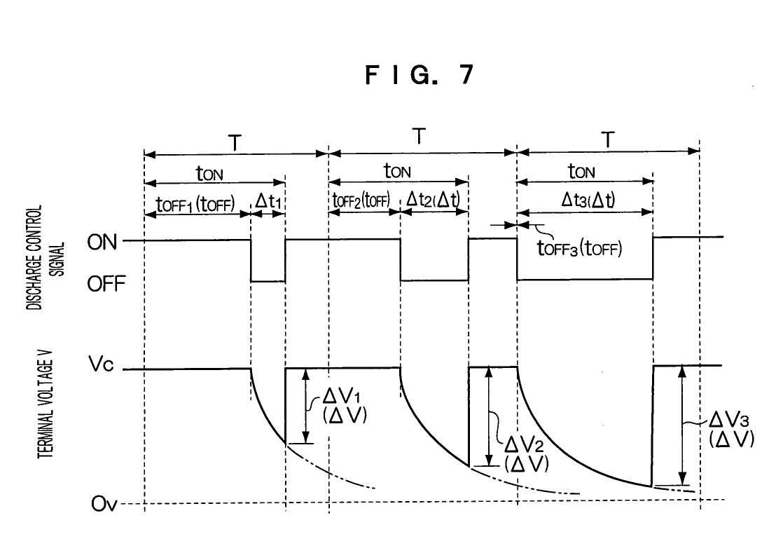

At this time, as shown in FIG. 7, the timing for turning off the gate switch 78 (off-timing t_{OFF}) is set, depending on the off-time Δt, so as to set constant the timing for turning on the gate switch 78 (on-timing t_{ON}) within one print period T. That is, in one print period, the off-timings t_{OFF} are determined for the respective off-times Δt according to:

$$\begin{matrix}{t}_{ON} = Δ t + {t}_{OFF} \\ = Δ t 1 + {t}_{OFF 1} ( small drop ) \\ = Δ t 2 + {t}_{OFF 2} ( medium drop ) \\ = Δ t 3 + {t}_{OFF 3} ( large drop )\end{matrix}$$

. In FIG. 7, it is set t_{ON}=Δt3, hence off-timing t_{OFF3}=0.

By on/off-controlling the gate switch 78 based on the off-time Δt and off-timing t_{OFF} determined as described above, dots can be formed in a manner such that the impact positions of ink droplets on the paper 16 are uniformly aligned so that and printing at high quality can be achieved.

### Second Embodiment

A second embodiment of the invention will next be described below. The basic configuration of the second embodiment is identical to that of the first embodiment. In the second embodiment, parts identical to those of the first embodiment are indicated by identical reference numerals, and duplicate explanation will be omitted.

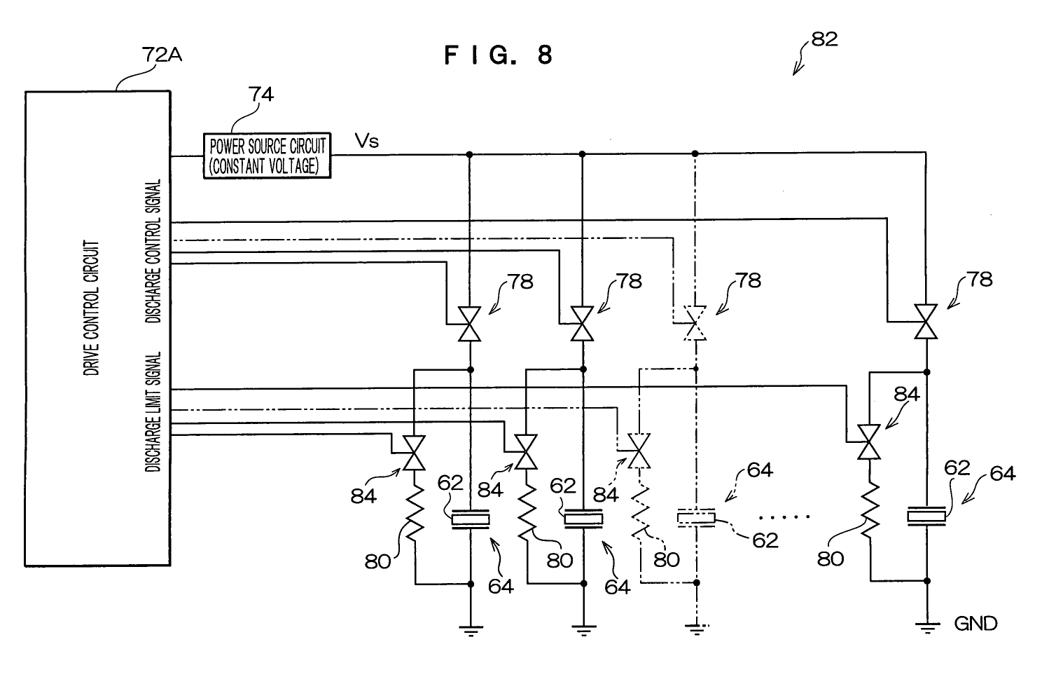

FIG. 8 shows an outline of a driving circuit 82 which is used in the second embodiment, instead of the driving circuit 76 in the first embodiment.

The driving circuit 82 includes a gate switch 84 as a second switching element. This gate switch is connected in series to the resistor 80.

Thus, in the driving circuit 82, a discharge from the piezoelectric element 62 which is caused when the gate switch 78 is turned off can be stopped by turning off the gate switch 84.

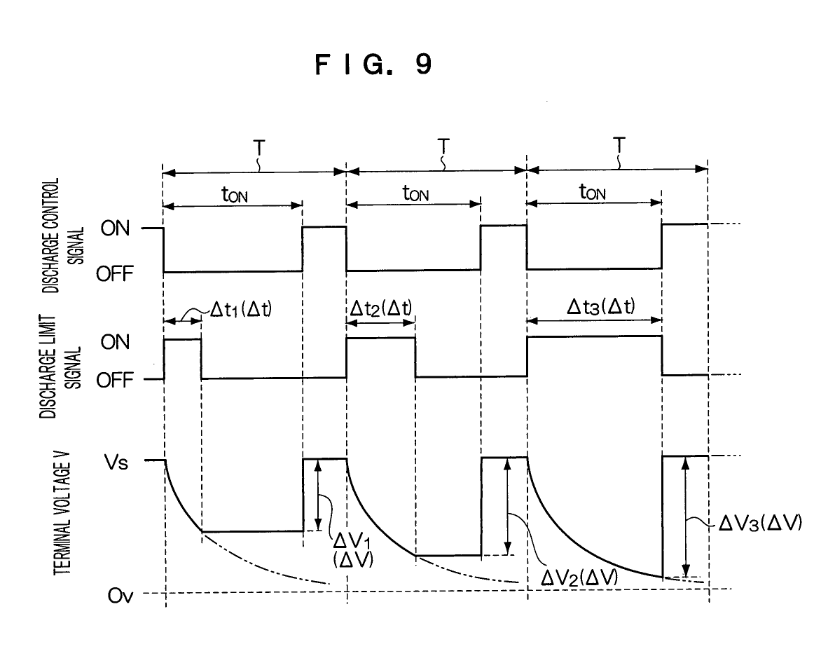

As shown in FIG. 9, when the discharge is stopped due to the gate switch 84 being turned off, the piezoelectric element 62 holds the terminal voltage V at the time when the gate switch 84 is turned off.

The driving circuit 82 is connected to a drive control circuit 72A, which is provided instead of the drive control circuit 72, as shown in FIG. 8. The drive control circuit 72A outputs a discharge limit signal as drive operation signal on the gate switch 84, together with discharge control signal for driving the gate switches 78 individually. The gate switch 84 is turned on or off by the discharge limit signal.

Thus, as shown in FIG. 9, in the driving circuit 82, the gate switch 84 is turned on in response to the discharge limit signal, and the gate switch 78 is turned off in response to the discharge control signal. Consequently, discharge from the piezoelectric element 62 is started.

In the driving circuit 82, when the gate switch 84 is turned off in response to the discharge limit signal while the OFF state of the gate switch 78 is maintained, the discharge from the piezoelectric element 62 is stopped. Thus, the terminal voltage V of piezoelectric element 62 is maintained at the voltage when the gate switch 84 is turned off.

Subsequently, the gate switch 78 is turned on, and charging of piezoelectric element 62 is started so that the terminal voltage V of the piezoelectric element 62 is increased up to the level of the voltage Vs which is supplied from the power source terminal 74.

In the driving circuit 84 having the above configuration, for example, supposing the ejected droplet amounts are small drop, medium drop and large drop, when the potential difference ΔV is ΔV1, ΔV2 and ΔV3, and the off-time lengths Δt necessary for obtaining the potential differences ΔV1, ΔV2 and ΔV3 are Δt1, Δt2, Δt3, the off-time of gate switch 84 is Δt, and the on-timing for starting charging the piezoelectric element 62 is t_{ON}.

In this manner, the liquid droplet ejector 64 is operable to eject at the same on-timing t_{ON} in one print period regardless of the ejected droplet amount and the off-time Δt of gate switch 78, and thus impact positions of ink droplets on the paper 16 can be aligned uniformly, and hence uniform printing is realized.

That is, the driving circuit 76 described above is arranged such that in order to align the landing positions of ink droplets, the off-timing t_{OFF} of gate switch 78 for starting discharge from piezoelectric element 62 is set on the basis of off-time Δt and on-timing t_{ON}, and the gate switch 78 is driven on the basis of the off-timing t_{OFF} and off-time Δt set as above.

Meanwhile, the driving circuit 82 is arranged such that the gate switch 78 is driven on the basis of off-time Δt, while at the same time the gate switch 84 is driven on the basis of on-timing t_{ON}, and landing positions on the paper 16 of ink droplets ejected from the liquid droplet ejector 64 can be aligned uniformly.

More specifically, simply by setting the on-timing t_{ON} and driving the gate switch 84 on the basis of the set on-timing t_{ON}, landing positions of ink droplets can be set at the positions determined based on the on-timing t_{ON}.

Through use of the driving circuit 82 described above, an image of high quality in which dots' positions are uniformly aligned can be easily formed.

Further, when the gate switch 78 is turned on by the discharge control signal, by turning off the gate switch 84 by discharge limit switch, the current flowing through the resistor 80, which serves as a discharge element, can be limited during charging of the piezoelectric element 62 as a result of the gate switch 84 being turned off by the discharge control signal, so that wasteful power consumption can be suppressed.

The driving circuit 82 may be arranged such that plural gate switches 84 are driven and operated by a single discharge limit signal. Alternatively, it may also be arranged such that the on-timing t_{ON} set for each gate switch 84, i.e., for each liquid droplet ejector 64.

When a misalignment of ink droplet landing positions in the sub-scanning direction of paper 16 occurs among plural ink droplet ejectors 64, the on-timing t_{ON} is corrected on the basis of the misalignment such that the ink droplet landing positions are aligned, whereby the misalignment of landing positions in the sub-scanning direction can be suppressed and an image of high quality can be formed.

The resistor 80, which is provided as discharging element in the foregoing explanation, may be provided also as a resistance element in an IC in which the gate switch 78 and etc. are formed in an integrated form for performing gate control. Alternatively, the resistor 80 may be provided in parallel with the piezoelectric element 62 externally of the IC. As compared with the formation of the resistor 80 in the IC, the provision of the resistor 80 in parallel with the piezoelectric element is advantageous in that heat generation of the IC's can be suppressed.

The embodiments explained above simply show examples of the invention, and is not intended to limit the structure of the invention. In the foregoing embodiments, description has been made of the ink jet recording device 10 by way of example, however, the present invention is by no means limited thereto and can be applied to an ink jet recording device having any structure that is designed so as to eject ink droplets through use of piezoelectric elements.

Further, the driving circuits 78, 82 used in the above embodiments show examples of driving circuit to which the invention is applied, and are not intended to limit the structure of the invention, and the invention may be applied to any other structures for controlling charge and discharge of the piezoelectric element 62.

Also in the embodiments, the liquid droplet ejecting device has been explained as ink jet recording device for performing image recording by ejecting ink droplets, however, the invention is by no means limited thereto, and can also be applied to a liquid droplet ejecting device of any structure that is designed so as to eject liquid droplets by using piezoelectric element such as piezo element as an actuator.

What is claimed is:

1. A driving circuit of a piezoelectric element provided as an actuator in a liquid droplet ejector in order to enable the liquid droplet ejector to eject a liquid droplet(s) by causing a pressure chamber of the liquid droplet ejector to be expanded and contracted in accordance with changes in a voltage applied to the piezoelectric element, comprising:
a power source that outputs power of a specified voltage which is applied to the piezoelectric element;
a discharging element connected in parallel with the piezoelectric element; and
a first switching element provided between the power source and the parallel connected piezoelectric element and discharging element, the first switching element being opened and closed in accordance with a first operation signal inputted thereto.

2. The driving circuit of a piezoelectric element of claim 1, further comprising a second switching element connected in series with the discharging element, the second switching element being opened and closed in accordance with a second operation signal inputted thereto.

3. The driving circuit of a piezoelectric element of claim 1, wherein the discharging element is a resistor having a resistance value that is set based on an electrostatic capacity of the piezoelectric element.

4. The driving circuit of a piezoelectric element of claim 2, wherein the discharging element is a resistor having a resistance value that is set based on an electrostatic capacity of the piezoelectric element.

5. A liquid droplet ejecting device comprising:
a liquid droplet ejector that ejects a liquid droplet(s) from a nozzle(s) in communication with a pressure chamber due to the pressure chamber being expanded and contracted in response to changes in a voltage applied to a piezoelectric element;
a power source that outputs power of a specified voltage for driving the piezoelectric element;
a charging unit that permits the piezoelectric element to be charged at the specified voltage with power outputted from the power source;
a discharging unit that permits the piezoelectric element charged at the specified voltage to be discharged; and
a drive control unit that controls charging and discharging of the piezoelectric element by the charging unit and the discharging unit, and drives the piezoelectric element, which has started being discharged by the discharging element, to change a terminal voltage thereof by being charged through the charging element.

6. The liquid droplet ejecting device according to claim 5, further comprising a discharge limiting unit that limits discharge of the piezoelectric element by the discharging unit, with the drive control unit controlling the discharge limiting unit.

7. The liquid droplet ejecting device according to claim 5, wherein:
the charging unit includes a first switching element provided between the power source and the piezoelectric element;
the discharging unit includes a resistor having a specified resistance value and connected in parallel to the piezoelectric element; and
the drive control unit controls charging and discharging of the piezoelectric element through on/off operation of the first switching element.

8. The liquid droplet ejecting device according to claim 6, wherein;
the charging unit includes a first switching element provided between the power source and the piezoelectric element,
the discharging unit includes a resistor having a specified resistance value and connected in parallel to the piezoelectric element; and
the drive control unit controls charging and discharging of the piezoelectric element through on/off operation of the first switching element.

9. The liquid droplet ejecting device according to claim 8, wherein the drive control unit controls operation of the first switching element based on an OFF time of the piezoelectric electrostatic determined by the electrostatic capacity of the piezoelectric element, the resistance value of the resistor, and the droplet ejection amount of the liquid droplet ejector.

10. The liquid droplet ejecting device according to claim 8, wherein:
the discharging unit includes a second switching element connected in series to the resistance; and
the drive control unit stops discharging of the piezoelectric element by turning off the second switching element.

11. The liquid droplet ejecting device according to claim 10, wherein the drive control unit controls the discharging start and charging start timing by operation of the first switching element, and controls the operation of the second switching element based on the electrostatic capacity of the piezoelectric element, the resistance value of the resistor, and the droplet ejection amount of the liquid droplet ejector.

12. The liquid droplet ejecting device according to claim 9, wherein the drive control unit controls so as to cause the first switching element to be switched between an OFF state and an ON state at a specified timing.

13. The liquid droplet ejecting device according to claim 10, wherein the drive control unit controls so as to cause the first switching element to be switched between an OFF state and an ON state at a specified timing.
